(19) United States
(12) Patent Application Publication
(10) Pub. No.: US 2005/0064181 A1
(43) Pub. Date: Mar. 24, 2005

(54) Pressure-sensitive adhesive tape for the adhesion of printing plates

(75) Inventors: Carsten Blank, Tostedt (DE); Jochen Fiencke, Hamburg (DE); Marc Husemann, Hamburg (DE); Torsten Runge, Hamburg (DE)

Correspondence Address: NORRIS, MCLAUGHLIN & MARCUS, PA, 875 THIRD STREET, 18TH FLOOR, NEW YORK, NY, 10022, US

(73) Assignee: Tesa AG, Hamburg (DE)

(21) Appl. No.: 10/496,217

(22) PCT Filed: Jan. 8, 2003
(86) PCT No.: PCT/EP03/00107

(30) Foreign Application Priority Data
Jan. 8, 2002 (DE) 102 00 364.5

(51) Int. Cl. B32B 27/30; B32B 27/28; C09J 5/00

(52) U.S. Cl. 428/354; 428/500; 428/26; 156/306.3

(57) ABSTRACT

The use of a pressure sensitive adhesive tape comprising self-crosslinking acrylic pressure sensitive adhesive for the adhesive bonding of printing plates, in particular to printing cylinders and/or printing sleeves.

The invention relates to pressure sensitive adhesive (PSA) tapes for bonding printing plates, at least the adhesive side facing the printing plate being composed of a self-crosslinking, in particular physically self-crosslinking, acrylic block copolymer.

The printing industry knows of a variety of techniques for transferring designs to paper, for example, by means of print originals. One possibility is that known as flexographic printing. One embodiment of flexographic printing, in turn, is the use of multilayer photopolymer printing plates with a flexible substructure, this type of printing having been part of the prior art for a relatively long time. The printing plates in this case are composed of a plurality of layers of different polymeric materials each with specific functions. For example, the “nyloflex MA” and “nyloflex ME” printing plates from BASF AG have three layers, namely a light-sensitive relief layer, a stabilizing film below it, and an elastic base layer.

In the flexographic printing process, flexible printing plates are bonded adhesively to printing cylinders or sleeves. This bonding is generally carried out using double-sided PSA tapes, on which very stringent requirements are imposed. For the printing process, the PSA tape is required to have a certain hardness but also a certain flexibility. These properties must be set very precisely in order that the printed image produced is free of errors. Further major requirements are imposed on the PSA itself, where the bond strength must likewise be high so that the printing plate does not detach from the double-sided PSA tape or the PSA tape from the cylinder. This must be so even at increased temperatures of 40-60° C. and at high printing speeds. In addition to this property, however, the PSA should also be reversible, since it is often necessary to bond the tape or the printing plates and then to detach them again for repositioning. This redetachability is relevant within the first period of time after bonding. Moreover, it is desired that the PSA tape and especially the printing plate can be removed again very easily and without great application of force following the printing process. In addition, no residues should remain on the printing plate or on the cylinder. In summary, then, very high requirements are imposed on the double-sided PSA tapes that are suitable for this application.

U.S. Pat. No. 4,380,956 describes a process for mounting a printing plate for the flexographic printing process. Pressure sensitive adhesives are used for this process too, but have not been specified in any greater detail.

GB 1,533,431 claims a double-sided PSA tape including an elastomeric layer which in turn is foamed by fragile air bubbles. The air bubbles are destroyed under pressure during flexographic printing application.

U.S. Pat. No. 4,574,697 claims double-sided PSA tapes comprising as their carrier material a flexible polyurethane foam affixed to a PET (polyethylene terephthalate) film. The outer layers are composed of pressure sensitive adhesives.

The PSA tape described is to be reversible and to be removable from the printing cylinder and from the printing plate. A similar product structure has been described in EP 0 206 760. There, the flexible foam carrier used was a polyethylene foam.

U.S. Pat. No. 4,574,712, in analogy to U.S. Pat. No. 4,574,697, describes a similar PSA tape construction. Here there is a restriction on the PSAs, namely that the bond strength to the printing plate and to the printing cylinder should be lower than to the carrier film and the carrier foam.

U.S. Pat. No. 3,983,287 describes a laminate whose carrier material comprises an incompressible elastomer. Compressibility is achieved by means of beads which are destroyed under pressure and which therefore produce flexibility.

U.S. Pat. No. 5,613,942 describes PSA tapes which are especially suitable for bonds on wet surfaces. It is mentioned, inter alia, that such tapes are suitable for bonding printing plates.

U.S. Pat. No. 5,476,712 likewise describes a double-sided PSA tape which is used in the flexographic printing process. This PSA tape contains, in turn, a thermoplastic elastomer, the structure present in this case being a cellular structure produced by means of expanding microparticles.

In the cases mentioned above, a very large number of different pressure sensitive adhesives are used. Natural rubber adhesives possess good tack properties but lack great shear strength at room temperature and age as a result of degradation via the double bonds present in the polymer.

SIS-based or SEBS-based PSAs are generally very soft and tacky and tend to soften at high temperatures as well. If the printing plate is bonded to the printing cylinder under tension using an SIS or SEBS PSA, the printing plate tends to detach, despite the fact that the bond strength is high.

Acrylic PSAs, on the other hand, are very suitable for bonding printing plates to printing cylinders but have to be crosslinked in the preparation process following the coating operation. Moreover, hard acrylic adhesives of low tack are of only limited availability, since the homopolymers of the acrylates generally possess a low glass transition temperature. An exception is formed by very long-chain acrylates or acrylate monomers of high molecular weight. In turn, however, these are very difficult to polymerize, i.e., polymerize very slowly, for steric reasons. Moreover, as a result of polar interactions, acrylic PSAs tend toward peel increase, with the consequence that, ultimately, the printing plate is very difficult to remove owing to a decrease in bond strength.

It is an object of the invention to enable the adhesive bonding of printing plates to printing sleeves or printing cylinders or the like; the adhesive bond ought to take place reversibly and without residue, and, in particular, the disadvantages of the prior art ought to be minimized or avoided.

The object is achieved surprisingly through the use of a self-crosslinking, in particular physically self-crosslinking, pressure sensitive adhesive, as described in greater detail below, and through pressure sensitive adhesive tapes provided with such a pressure sensitive adhesive. The invention allows residue-free and nondestructive detachment of the printing plate from the substrate on which it has been bonded.

Claim 1 relates accordingly to the use of a pressure sensitive adhesive tape comprising a self-crosslinking acrylic pressure sensitive adhesive for the adhesive bonding of printing plates, particularly to printing cylinders and/or printing sleeves.

Where reference is made, here and below, to “acrylates” and “acrylic pressure sensitive adhesive”, these terms explicitly include the corresponding methacrylates and methacrylic pressure sensitive adhesives, and also, correspondingly, pressure sensitive adhesives based on acrylates and methacrylates.

The pressure sensitive adhesive tape is used in particular for attaching multilayer photopolymer printing plates to printing cylinders or printing sleeves.

The pressure sensitive adhesive tape is advantageously of the kind which is adhesive on both sides. In accordance with the invention the pressure sensitive adhesive is advantageously chosen such that it is able automatically, without further technical modifications, through self-organization to form adhesive and nonadhesive segments, in particular through phase separation or microphase separation.

One advantageous version of the use in accordance with the invention takes a form, accordingly, such that the pressure sensitive adhesive is in the form of at least one layer, said at least one layer of pressure sensitive adhesive having adhesive and nonadhesive regions, in particular in the form of domains (disperse phase) in a matrix (continuous phase).

With particular preference the self-crosslinking pressure sensitive adhesives used for the use in accordance with the invention allow residue-free and nondestructive detachment of the printing plate from the substrate on which it has been bonded.

The pressure sensitive adhesive tape preferably comprises at least one carrier, in the form in particular of a film, a foam (a foam material) and/or a composite of the two aforementioned. The adhesive bonding of the printing plate to the pressure sensitive adhesive tape takes place preferably such that the at least one layer of the self-crosslinking pressure sensitive adhesive is on the side of the pressure sensitive adhesive tape that faces the printing plate.

In the case of a double-face-coated pressure sensitive adhesive tape the second pressure sensitive adhesive layer may likewise be composed of a self-crosslinking pressure sensitive adhesive; depending on the area of application, however, it may also be of advantage to use another, prior art pressure sensitive adhesive or adhesive. Where the adhesive tape has a self-crosslinking pressure sensitive adhesive layer on both sides, the pressure sensitive adhesive tape can be removed not only from the printing plate but also, very easily and without residue, from the printing cylinder or printing sleeve.

It is likewise possible to use the adhesive tape “invertedly”, in other words such that the side of the side of the adhesive tape that faces away from the printing plate is a self-crosslinking pressure sensitive adhesive and that which lies on the sides of the printing plate is an adhesive on a different basis. In that case, the details given below regarding the individual pressure sensitive adhesive layers should be read as referring, correspondingly, to the respective other pressure sensitive adhesive layer.

With particular advantage the self-crosslinking pressure sensitive adhesive used can be one based on at least one block copolymer. It has surprisingly been found that pressure sensitive adhesives based on acrylate block copolymer exhibit a series of advantages for the use in accordance with the invention:
possibility of using a large number of monomers for synthesizing the block copolymers and for preparing the PSA, so that a broad pallet of pressure sensitive adhesion properties can be set by means of the chemical composition;
enablement of the preparation of thick, highly cohesive PSA layers in particular for repositionable PSA tapes;
possibility of omitting an additional crosslinking, particularly an operation of crosslinking by actinic irradiation,
possibility of choice in the use of comonomers, allowing control of the thermal shear strength, and in particular a persistently good cohesion and thus good holding power at high temperatures (e.g. >+60° C.);
reversibility on a variety of surfaces.

Particular preference is given to using such pressure sensitive adhesives in which the at least one block copolymer comprises at least the unit P(A)-P(B)-P(A) composed of at least one polymer block P(B) and at least two polymer blocks P(A), where
P(A) independently of one another represent homopolymer and/or copolymer blocks of monomers A, the polymer blocks P(A) each having a softening temperature in the range from +20° C. to +175° C.,
P(B) represents a homopolymer or copolymer block of monomers B, the polymer block P(B) having a softening temperature in the range from −130° C. to +10° C., and
and the polymer blocks P(A) and P(B) are not homogeneously miscible with one another.

The softening temperature in this context is the glass transition temperature in the case of amorphous systems and the melting temperature in the case of semicrystalline polymers. Glass temperatures are reported as results of quasi static methods such as Differential Scanning Calorimetry, for example.

PSA systems which have been found particularly advantageous in the sense of the invention for the bonding of printing plates are those wherein the structure of at least one block copolymer can be described by one or more of the following general formulae:
P(A)-P(B)-P(A) (I)
P(B)-P(A)-P(B)-P(A)-P(B) (II)
[P(B)-P(A)]ₙX (III)
[P(B)-P(A)]ₙX[P(A)]ₘ (IV),
wherein n=3 to 12, m=3 to 12, and X represents a polyfunctional branching unit, i.e., a chemical building block via which several polymer arms are linked to one another,
wherein the polymer blocks P(A) independently of one another represent homopolymer and/or copolymer blocks of the monomers A, the polymer blocks P(A) each having a softening temperature in the range from +20° C. to +175° C., and
wherein the polymer blocks P(B) independently of one another represent homopolymer and/or copolymer blocks of the monomers B, the polymer blocks P(B) each having a softening temperature in the range between −130° C. to +10° C.

As the basis for the pressure sensitive adhesives it is also possible to choose two or more different acrylate-based block copolymers. In that case two or more, with particular preference all, of the block copolymers can be described preferably by one or more of the above formulae.

The fraction of the block copolymers as a proportion of the pressure sensitive adhesive is preferably in total at least 50% by weight.

The polymer blocks P(A) can comprise polymer chains in a single monomer type from group A, or copolymers of monomers of different structures from group A. In particular, the monomers A used can vary in their chemical structure and/or in the side chain length. The polymer blocks therefore span the range between completely homogeneous polymers, via polymers composed of monomers of identical chemical parent structure but differing in chain length, and those with the same number of carbon atoms but different isomerism, through to randomly polymerized blocks composed of monomers of different lengths with different isomerism from group A. The same applies to the polymer blocks P(B) in respect of the monomers from group B.

The unit P(A)-P(B)-P(A) may be either symmetrical [corresponding to P¹(A)-P(B)-P²(A) where P¹(A)=P²(A)] or asymmetric [corresponding, for instance, to the formula P³(A)-P(B)-P⁴(A) where P³(A)≠P⁴(A), but where both P³(A) and P⁴(A) are each polymer blocks as defined for P(A)] in construction.

An advantageous configuration is one in which the block copolymers have a symmetrical construction such that there are polymer blocks P(A) identical in chain length and/or chemical structure and/or there are polymer blocks P(B) identical in chain length and/or chemical structure.

P³(A) and P⁴(A) may differ in particular in their chemical composition and/or in their chain length.

As monomers for the elastomer block P(B) it is advantageous to use acrylic monomers. For this purpose it is possible in principle to use all acrylic compounds which are familiar to the skilled worker and are suitable for synthesizing polymers. It is preferred to choose monomers which, even in combination with one or more further monomers, produce polymer block P(B) glass transition temperatures of less than +10° C. and reduce the surface tension.

Accordingly, it is possible with preference to choose the vinyl monomers.

In order to obtain a polymer glass transition temperature, T_{G}, of <10° C. in accordance with the comments made above and below, the monomers are very preferably selected in such a way, and the quantitative composition of the monomer mixture advantageously chosen in such a way, that the polymer has the desired T_{G} in accordance with equation (G1) (in analogy to the Fox equation; cf. T. G. Fox, Bull. Am. Phys. Soc. 1 (1956) 123):

$$\frac{1}{{T}_{G}} = {\sum }_{n} \frac{{w}_{n}}{{T}_{G , n}} \qquad ( G1 )$$

In this equation, n represents the serial number of the monomers used, wₙ represents the mass fraction of the respective monomer n (% by weight), and T_{G,n} represents the respective glass transition temperature of the homopolymer of the respective monomer n, in K.

The polymer blocks P(B) are advantageously prepared using from 75 to 100% by weight of acrylic and/or methacrylic acid derivatives of the general structure
CH₂═CH(R¹)(COOR²) (V)
where R¹=H or CH₃ and R²=H or linear, branched or cyclic, saturated or unsaturated, alkyl radicals having from 1 to 30, in particular from 4 to 18, carbon atoms, and, if desired, up to 25% by weight of vinyl compounds (VI), which in favorable cases contain functional groups.

Acrylic monomers used with great preference within the meaning of compound (V) as components of polymer blocks P(B) comprise acrylic and methacrylic esters with alkyl groups composed of from 4 to 18 carbon atoms. Specific examples of such compounds, without wishing to be restricted by this enumeration, include n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, branched isomers thereof, such as 2-ethylhexyl acrylate and isooctyl acrylate, for example, and also cyclic monomers such as cyclohexyl acrylate or norbornyl acrylate and isobornyl acrylate, for example.

As an option, it is also possible to use vinyl monomers from the following groups as monomers within the definition (VI) for polymer blocks P(B): vinyl ester, vinyl ether, vinyl halides, vinylidene halides, and also vinyl compounds which comprise aromatic cycles and heterocycles in the a position. Here too, mention may be made, by way of example, of selected monomers which can be used in accordance with the invention: vinyl acetate, vinyl formamide, vinyl pyridine, ethyl vinyl ether, 2-ethylhexyl vinyl ether, butyl vinyl ether, vinyl chloride, vinylidene chloride, and acrylonitrile.

Particularly preferred examples of suitable vinyl-containing monomers as defined for (VI) for the elastomer block P(B) further include hydroxyethyl acrylate, hydroxypropyl acrylate, hydroxyethyl methacrylate, hydroxypropyl methacrylate, n-methylolacrylamide, acrylic acid, methacrylic acid, allyl alcohol, maleic anhydride, itaconic anhydride, itaconic acid, benzoin acrylate, acrylated benzophenone, acrylamide, and glycidyl methacrylate, to name but a few.

In one preferred embodiment of the pressure sensitive adhesive systems for bonding printing plates, one or more of the polymer blocks contain one or more grafted-on side chains. No restriction is imposed as to whether such systems are obtained by means of a graft-from process (polymerizational attachment of a side chain starting from an existing polymer backbone) or graft-to process (attachment of polymer chains to a polymer backbone by means of polymer-analogous reactions).

For preparing block copolymers of this type it is possible in particular to use, as monomers B, monomers functionalized in such a way as to allow a graft-from process for the grafting on of side chains. Particular mention may be made here of acrylic and methacrylic monomers which carry halogen functionalization or functionalization provided by any other functional groups which permit, for example, an ATRP (atom transfer radical polymerization) process. In this context, mention may also be made of the possibility of introducing side chains into the polymer chains in a targeted way via macromonomers. The macromonomers may in turn be constructed in accordance with the monomers B.

In one specific embodiment of this invention, the polymer blocks P(B) have had incorporated into them one or more functional groups which permit radiation-chemical crosslinking of the polymer blocks, in particular by means of UV irradiation or irradiation with rapid electrons. With this objective, monomer units which can be used include, in particular, acrylic esters containing an unsaturated alkyl radical having from 3 to 18 carbon atoms and at least one carbon-carbon double bond. Suitable acrylates modified with double bonds include, with particular advantage, allyl acrylate and acrylated cinnamates. Besides acrylic monomers it is also possible with great advantage, as monomers for the polymer block P(B), to use vinyl compounds containing double bonds which are not reactive during the (free-radical) polymerization of the polymer blocks P(B). Particularly preferred examples of such comonomers are isoprene and/or butadiene, and also chloroprene.

Starting monomers for the polymer blocks P(A) are preferably selected such that the resulting polymer blocks P(A) are imiscible with the polymer blocks P(B) and, correspondingly, microphase separation occurs. Advantageous examples of compounds used as monomers A include vinyl aromatics, methyl methacrylate, cyclohexyl methacrylate, isobornyl methacrylate, and isobornyl acrylate.

Particularly preferred examples are methyl methacrylate and styrene, although this enumeration makes no claim to completeness.

In addition, however, the polymer blocks P(A) may also be constructed in the form of a copolymer which can consist of at least 75% of the above monomers A, leading to a high softening temperature, or of a mixture of these monomers, but contains up to 25% of monomers B which lead to a reduction in the softening temperature of the polymer block P(A) and/or further reduce the surface energy. In this sense mention may be made, by way of example but not exclusively, of alkyl acrylates, which are defined in accordance with the structure (V) and the comments made in relation thereto.

In another favorable embodiment of the inventive pressure sensitive adhesive, polymer blocks P(A) and/or P(B) are functionalized in such a way that a thermally initiated crosslinking can be accomplished. Crosslinkers which can be chosen favorably include: epoxides, aziridines, isocyanates, polycarbodiimides, and metal chelates, to name but a few.

One preferred characteristic of the block copolymers used for the PSA systems of the invention is that their molar mass Mₙ is between about 10 000 and about 600 000 g/mol, preferably between 30 000 and 400 000 g/mol, with particular preference between 50 000 g/mol and 300 000 g/mol. The polymer block P(A) fraction is advantageously between 5 and 49 percent by weight of the overall block copolymer, preferably between 7.5 and 35 percent by weight, with particular preference between 10 and 30 percent by weight. The polydispersity of the block copolymer is preferably less than 3, being the quotient formed from the mass average M_{w} and number average Mₙ of the molar mass distribution.

In a very advantageous procedure, the ratios of the chain lengths of the block copolymers P(A) to those of the block copolymers P(B) are chosen such that the block copolymers P(A) are present as a disperse phase (“domains”) in a continuous matrix of the polymer blocks P(B). This is preferably the case at a polymer blocks P(A) content of less than 25% by weight. The domains may preferably be in the form of regular or distorted spheres. The formation of hexagonally packed cylindrical domains of the polymer blocks P(A) is likewise possible within the inventive context. In a further embodiment, an asymmetric design of the triblock copolymers is the objective, with the block lengths of the terminal polymer blocks P(A) in linear systems being different. The sphere morphology is particularly preferred when it is necessary to increase the internal strength of the pressure sensitive adhesive, and also for improving the mechanical properties.

With particular preference, according to the invention, the M_{N} molecular weight of the middle block P(B) is limited to 200 000 g/mol, since as a result of the shorter polymer segments between the hard blocks P(A) these blocks move to the surface in greater numbers and hence the screen printing effect through the hard domains is particularly pronounced.

Moreover, it may be advantageous to use blends of the abovementioned block copolymers with diblock copolymers P(A)-P(B), the monomers used to prepare the corresponding polymer blocks P(A) and P(B) possibly being the same as those used above. It may further be of advantage to add polymers P′(A) and/or P′(B) to the pressure sensitive adhesive composed of the block copolymers, especially of triblock copolymers (I), or of a block copolymer/diblock copolymer blend, for the purpose of improving its properties.

The invention further provides, accordingly, reversible systems wherein the pressure sensitive adhesive comprises a blend of one or more block copolymers with a diblock copolymer P(A)-P(B),
where the polymer blocks P(A) (of the individual diblock copolymers) independently of one another represent homopolymer and/or copolymer blocks of the monomers A, the polymer blocks P(A) each having a softening temperature in the range from +20° C. to +175° C.,
where the polymer blocks P(B) (of the individual diblock copolymers) independently of one another represent homopolymer and/or copolymer blocks of the monomers B, the polymer blocks P(B) each having a softening temperature in the range from −130° C. to +10° C.,
   and/or with polymers P′(A) and/or P′(B),
where the polymers P′(A) represent homopolymers and/or copolymers of the monomers A, the polymers P′(A) each having a softening temperature in the range from +20° C. to +175° C.,
where the polymers P′(B) represent homopolymers and/or copolymers of the monomers B, the polymers P′(B) each having a softening temperature in the range from −130° C. to +10° C.,
where the polymers P′(A) and P′(B) are preferably miscible with the polymer blocks P(A) and P(B) respectively.

Where both polymers P′(A) and polymers P′(B) have been admixed, they are advantageously chosen such that the polymers P′(A) and P′(B) are not homogeneously miscible with one another.

As monomers for the diblock copolymers P(A)-P(B), and for the polymers P′(A) and P′(B) respectively, it is preferred to use the monomers already mentioned from groups A and B.

The diblock copolymers preferably have a molar mass Mₙ of between 5 000 and 600 000 g/mol, more preferably between 15 000 and 400 000 g/mol, with particular preference between 30 000 and 300 000 g/mol. They advantageously possess a polydispersity D=M_{w}/Mₙ of not more than 3. It is advantageous if the fraction of the polymer blocks P(A) in the composition of the diblock copolymer is between 3 and 50% by weight, preferably between 5 and 35% by weight.

Advantageously, the diblock copolymers may also have one or more grafted-on side chains.

Typical concentrations in which diblock copolymers are used in the blend are up to 250 parts by weight per 100 parts by weight of higher block copolymers comprising the unit P(A)-P(B)-P(A). The polymers P′(A) and P′(B) respectively may be constructed as homopolymers and also as copolymers. In accordance with the comments made above, they are advantageously chosen so as to be compatible with the block copolymers P(A) and P(B) respectively. The chain length of the polymers P′(A) and P′(B) respectively is preferably chosen such that it does not exceed that of the polymer block which is preferably miscible and/or associable with it, and is advantageously 10% lower, very advantageously 20% lower, than said length. The B block may also be chosen so that its length does not exceed half of the length of the B block of the triblock copolymer.

To prepare the block copolymers employed in the pressure sensitive adhesives used according to the invention it is possible in principle to use all polymerizations which proceed in accordance with a controlled-growth or living mechanism, including combinations of different controlled polymerization techniques. Without possessing any claim to completeness, mention may be made here, by way of example, besides anionic polymerization, of ATRP, nitroxide/TEMPO-controlled polymerization, or, more preferably, the RAFT process; in other words, particularly those processes which allow control over the block lengths, polymer architecture, or else, but not necessarily, the tacticity of the polymer chain.

Free-radical polymerizations can be conducted in the presence of an organic solvent or in the presence of water, or in mixtures of organic solvents and/or organic solvents with water, or without solvent. It is preferred to use as little solvent as possible. Depending on conversion and temperature, the polymerization time for free-radical processes is typically between 4 and 72 h.

In the case of solution polymerization, the solvents used are preferably esters of saturated carboxylic acids (such as ethyl acetate), aliphatic hydrocarbons (such as n-hexane, n-heptane or cyclohexane), ketones (such as acetone or methyl ethyl ketone), special boiling point spirit, aromatic solvents such as toluene or xylene, or mixtures of the aforementioned solvents. For polymerization in aqueous media or in mixtures of organic and aqueous solvents, it is preferred to add emulsifiers and stabilizers for the polymerization. As polymerization initiators it is of advantage to use customary radical-forming compounds such as, for example, peroxides, azo compounds, and peroxosulfates. Initiator mixtures also possess outstanding suitability.

In an advantageous procedure, radical stabilization is effected using nitroxides of type (NIT 1) or (NIT 2): 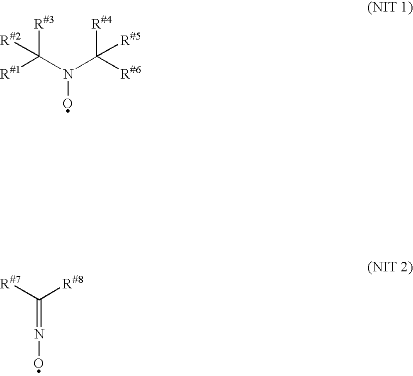
where R^{#1}, R^{#2}, R^{#3}, R^{#4}, R^{#5}, R^{#6}, R^{#7}, and R^{#8}, independently of one another, denote the following compounds or atoms:
i) halides, such as chlorine, bromine or iodine
ii) linear, branched, cyclic, and heterocyclic hydrocarbons having from 1 to 20 carbon atoms, which can be saturated, unsaturated or aromatic,
iii) esters —COOR^{#9}, alkoxides —OR^{#10} and/or phosphonates —PO(OR^{#11})₂, in which R^{#9}, R^{#10}, and/or R^{#11} stand for radicals from group ii).

Compounds of the structure (NIT 1) or (NIT 2) may also be attached to polymer chains of any kind (primarily in the sense that at least one of the abovementioned radicals constitutes such a polymer chain) and can therefore be used as macroradicals or macroregulators to construct the block copolymers.

More preferred are controlled regulators for the polymerization of compounds of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl pyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide

A number of other polymerization methods by which the PSAs can alternatively be prepared may be chosen from the state of the art:

U.S. Pat. No. 4,581,429 A discloses a controlled-growth radical polymerization process initiated using a compound of the formula R^{I}R^{II}N-O-Y in which Y is a free radical species which is able to polymerize unsaturated monomers. The reactions, however, generally have low conversions. The particular problem is the polymerization of acrylates, which proceeds only to very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process using very specific radical compounds such as, for example, phosphorus-containing nitroxides which are based on imidazolidine. WO 98/44008 A1 discloses specific nitroxyls based on morpholines, piperazinones, and piperazinediones. DE 199 49 352 A1 describes heterocyclic alkoxyamines as regulators in controlled-growth radical polymerizations. Corresponding further developments of the alkoxyamines and/or of the corresponding free nitroxides improve the efficiency for preparing polyacrylates (Hawker, contribution to the National Meeting of the American Chemical Society, Spring 1997; Husemann, contribution to the IUPAC World Polymer Meeting 1998, Gold Coast).

As a further controlled polymerization method, it is possible advantageously to use atom transfer radical polymerization (ATRP) to synthesize the block copolymers, with preferably monofunctional or difunctional secondary or tertiary halides being used as initiator and, to abstract the halide(s), complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The different possibilities of ATRP are also described in the documents U.S. Pat. No. 5,945,491 A, U.S. Pat. No. 5,854,364 A, and U.S. Pat. No. 5,789,487 A.

It is also possible with advantage to prepare the block copolymer used in accordance with the invention by means of an anionic polymerization. In this case the reaction medium used preferably comprises inert solvents, such as aliphatic and cycloaliphatic hydrocarbons, for example, or else aromatic hydrocarbons.

The living polymer is generally represented by the structure P_{L}(A)-Me, in which Me is a metal from group I of the Periodic Table, such as lithium, sodium or potassium, for example, and P_{L}(A) is a growing polymer block made up of the monomers A. The molar mass of the polymer block being prepared is determined by the ratio of initiator concentration to monomer concentration. In order to construct the block structure, first of all the monomers A are added for the construction of a polymer block P(A), then, by adding the monomers B, a polymer block P(B) is attached, and subsequently, by again adding monomers A, a further polymer block P(A) is polymerized on, so as to form a triblock copolymer P(A)-P(B)-P(A). Alternatively, P(A)-P(B)-M can be coupled by means of a suitable difunctional compound. In this way, starblock copolymers (P(B)-P(A))ₙ as well are obtainable. Examples of suitable polymerization initiators include n-propyllithium, n-butyllithium, sec-butyllithium, 2-naphthyllithium, cyclohexyllithium, and octyllithium, but this enumeration makes no claim to completeness. Furthermore, initiators based on samarium complexes are known for the polymerization of acrylates (Macromolecules, 1995, 28, 7886) and can be used here.

It is also possible, moreover, to use difunctional initiators, such as 1,1,4,4-tetraphenyl-1,4-dilithiobutane or 1,1,4,4-tetraphenyl-1,4-dilithioisobutane. Coinitiators may likewise be used. Suitable coinitiators include lithium halides, alkali metal alkoxides, and alkylaluminum compounds. In one very preferred version, the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

A very preferred preparation process conducted is a variant of the RAFT polymerization (reversible addition-fragmentation chain transfer polymerization). The polymerization process is described in detail, for example, in the documents WO 98/01478 A1 and WO 99/31144 A1. Suitable with particular advantage for the preparation of triblock copolymers are trithiocarbonates of the general structure R^{III}-S-C(S)-S-R^{III} (Macromolecules 2000, 33, 243-245), by means of which, in a first step, monomers for the endblocks P(A) are polymerized. Then, in a second step, the middle block P(B) is synthesized. Following the polymerization of the endblocks P(A), the reaction can be terminated and reinitiated. It is also possible to carry out polymerization sequentially without interrupting the reaction. In one very advantageous variant, for example, the trithiocarbonates (VIII) and (IX) or the thio compounds (X) and (XI) are used for the polymerization, it being possible for Φ to be a phenyl ring, which can be unfunctionalized or functionalized by alkyl or aryl substituents attached directly or via ester or ether bridges, or can be a cyano group, or can be a saturated or unsaturated aliphatic radical. The phenyl ring Φ may optionally carry one or more polymer blocks, examples being polybutadiene, polyisoprene, polychloroprene or poly(meth)acrylate, which can be constructed in accordance with the definition of P(A) or P(B), or polystyrene, to name but a few. Functionalizations may, for example, be halogens, hydroxyl groups, epoxide groups, groups containing nitrogen or sulfur, with this list making no claim to completeness.

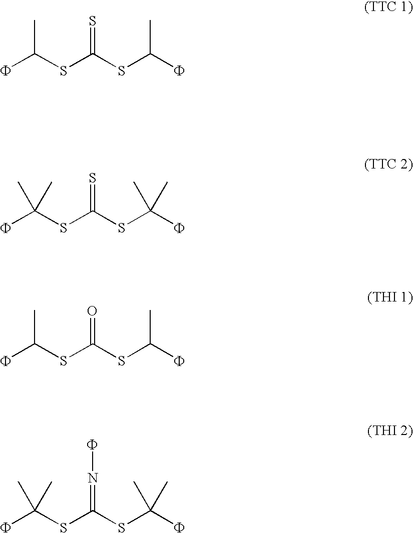

It is also possible to employ thioesters of the general structure
R^{$1}—C(S)—S—R^{$2} (THE)
especially in order to prepare asymmetric systems. R^{$1} and R^{$2} can be selected independently of one another, and R^{$1} can be a radical from one of the following groups i) to iv) and R^{$2} a radical from one of the following groups i) to iii):
i) C₁ to C₁₈ alkyl, C₂ to C₁₈ alkenyl, C₂ to C₁₈ alkynyl, each linear or branched; aryl-, phenyl-, benzyl-, aliphatic and aromatic heterocycles.
ii) —NH₂, —NH—R^{$3}, —NR^{$3}R^{$4}, —NH—C(O)—R^{$3}, —NR^{$3}—C(O)—R^{$4}, —NH—C(S)—R^{$3}, —NR^{$3}—C(S)—R^{$4}, 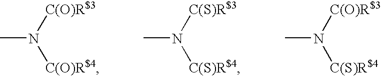
with R^{$3} and R^{$4} being radicals selected independently of one another from group i).
iii) —S—R^{$5}, —S—C(S)—R^{$5}, with R^{$5} being able to be a radical from one of groups i) or ii).
iv) —O—R^{$6}, —O—C(O)—R^{$6}, with R^{$6} being able to be a radical chosen from one of the groups i) or ii).

In connection with the abovementioned polymerizations which proceed by controlled-growth free-radical mechanisms, it is preferred to use initiator systems which further comprise additional radical initiators for the polymerization, especially thermally decomposing radical-forming azo or peroxo initiators. In principle, however, all customary initiators known for acrylates are suitable for this purpose. The production of C-centered radicals is described in Houben-Weyl, Methoden der Organischen Chemie, Vol. E19a, p. 60 ff. These methods are employed preferentially. Examples of radical sources are peroxides, hydroperoxides, and azocompounds. A few nonexclusive examples of typical radical initiators that may be mentioned here include potassium peroxodisulfate, dibenzoyl peroxide, cumene hydroperoxide, cyclohexanone peroxide, cyclohexylsulfonyl acetyl peroxide, di-tert-butyl peroxide, azodiisobutyronitrile, diisopropyl percarbonate, tert-butyl peroctoate, and benzpinacol. In one very preferred variant, the radical initiator used is 1,1′-azobis(cyclohexylnitrile) (Vazo 88®, DuPont®) or 2,2-azobis(2-methylbutanenitrile) (Vazo 67®, DuPont®). Furthermore, it is also possible to use radical sources which release radicals only under UV irradiation.

In the conventional RAFT process, polymerization is generally carried out only to low conversions (WO 98/01478 A1), in order to obtain very narrow molecular weight distributions. Because of the low conversions, however, these polymers cannot be used as pressure sensitive adhesives and particularly not as hotmelt pressure sensitive adhesives, since the high residual monomer fraction adversely affects the adhesive technological properties, the residual monomers contaminate the solvent recyclate in the concentration process, and the corresponding self-adhesive tapes would exhibit very high outgassing.

The abovedescribed pressure sensitive adhesives can be coated from solution or from the melt. In one embodiment of the invention, the solvent is stripped off preferably in a concentrative extruder under reduced pressure, it being possible to use, for example, single-screw or twin-screw extruders for this purpose, which preferentially distill off the solvent in different or the same vacuum stages and which possess a feed preheater.

For advantageous further development in accordance with the invention, tackifier resins may be admixed to the block copolymer pressure sensitive adhesives. In principle, it is possible to use all resins soluble in the corresponding polyacrylate middle block P(B). Suitable tackifier resins include rosin and rosin derivatives (rosin esters, including rosin derivatives stabilized by, for example, disproportionation or hydrogenation) polyterpene resins, terpene-phenolic resins, alkylphenol resins, and aliphatic, aromatic and aliphatic-aromatic hydrocarbon resins, to name but a few. Primarily, the resins chosen are those which are compatible preferentially with the elastomer block. The weight fraction of the resins in the block copolymer is typically up to 40% by weight, more preferably up to 30% by weight.

For one special embodiment of the invention it is also possible to use resins compatible with the polymer block P(A).

It is also possible, optionally, to add plasticizers, fillers (e.g., fibers, carbon black, zinc oxide, titanium dioxide, chalk, solid or hollow glass beads, microbeads of other materials, silica, silicates), nucleators, blowing agents, compounding agents and/or aging inhibitors, in the form of primary and secondary antioxidants or in the form of light stabilizers, for example.

The internal strength (cohesion) of the pressure sensitive adhesive is preferably produced by physical crosslinking of the polymer blocks P(A). The resulting physical crosslinking is typically thermoreversible. For irreversible crosslinking, the adhesives may additionally be crosslinked chemically. For this purpose, the acrylic block copolymer pressure sensitive adhesives used for the reversible systems of the invention can optionally comprise compatible crosslinking substances. Examples of suitable crosslinkers include metal chelates, polyfunctional isocyanates, polyfunctional amines, and polyfunctional alcohols. Additionally, polyfunctional acrylates can be used with advantage as crosslinkers for actinic radiation.

For the optional crosslinking with UV light, UV-absorbing photoinitiators are added to the polyacrylate-containing block copolymers employed in the systems of the invention. Useful photoinitiators which can be used to great effect are benzoin ethers, such as benzoin methyl ether and benzoin isopropyl ether, for example, substituted acetophenones, such as 2,2-diethoxyacetophenone (available as Irgacure 651® from Ciba Geigy®), 2,2-dimethoxy-2-phenyl-1 -phenylethanone, dimethoxyhydroxy-acetophenone, substituted □-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime.

The abovementioned photoinitiators and others which can be used, including those of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholinyl ketone, aminoketone, azobenzoin, thioxanthone, hexarylbisimidazole, triazine or fluorenone, it being possible for each of these radicals to be further substituted by one or more halogen atoms and/or one or more alkyloxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. For further details, consult Carroy et al. in “Chemistry and Technology of UV and EB Formulation for Coatings, Inks and Paints”, Oldring (ed.), 1994, SITA, London.

In principle it is also possible to crosslink the pressure sensitive adhesives used in accordance with the invention using electron beams. Typical irradiation devices which may be employed are linear cathode systems, scanner systems, and segmented cathode systems, in the case of electron beam accelerators. A detailed description of the state of the art, and the most important process parameters, can be found in Skelhorne, Electron Beam Processing, in Chemistry and Technology of UV and EB Formulation for Coatings, Inks and Paints, Vol. 1, 1991, SITA, London. The typical acceleration voltages are situated within the range between 50 kV and 500 kV, preferably between 80 kV and 300 kV. The radiation doses used range between 5 to 150 kGy, in particular between 20 and 100 kGy.

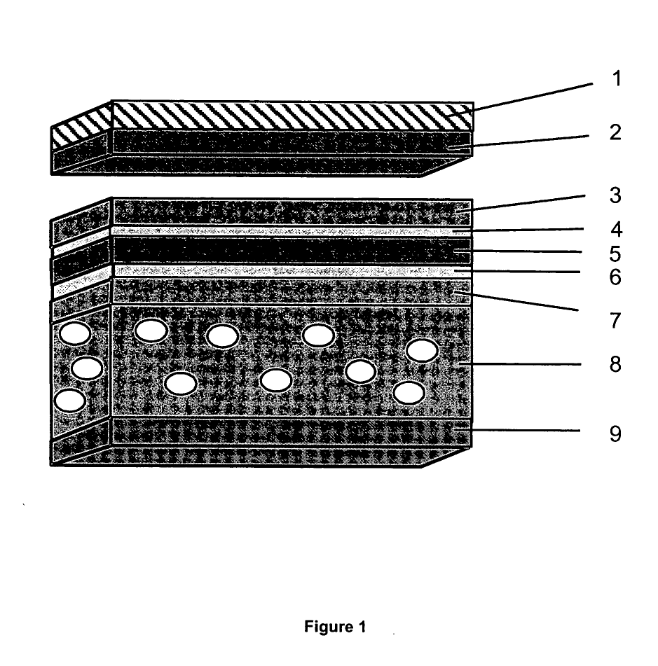

For the side of the pressure sensitive adhesive tape that faces the printing cylinder (referred to below as “opposite pressure sensitive adhesive layer”; see for example FIG. 1, layer 9. There are references, accordingly, to opposite pressure sensitive adhesive”, meaning the pressure sensitive adhesive which serves as pressure sensitive adhesive for forming the opposite pressure sensitive adhesive layer) it is possible in principle to use all pressure sensitive adhesives known to the skilled worker. Those suitable include, for example, rubber-based PSAs, synthetic rubber PSAs, PSAs based on polysilicones, polyurethanes, polyolefins or polyacrylates.

The opposite pressure sensitive adhesive can preferably be a conventional polyacrylate pressure sensitive adhesive; in a second preferred version it is a self-crosslinking pressure sensitive adhesive based on the block copolymers.

The opposite PSA systems can have the same composition as or a different composition from those on the printing plate side. The composition corresponds advantageously to the pressure sensitive adhesive already described that faces the printing plate.

The acrylic pressure sensitive adhesives are composed with particular preference of at least 50% by weight of polymers of acrylic ester and/or methacrylic ester and/or their free acids with the following formula
CH₂═CH(R₁)(COOR₂),
where R₁=H or CH₃ and R₂ is a hydrocarbon chain having 1-30 carbon atoms or H.

For the polymerization the monomers are chosen such that the resulting polymers can be used as pressure sensitive adhesives at room temperature or higher temperatures, especially such that the resulting polymers possess pressure sensitive adhesive properties in accordance with the “Handbook of Pressure Sensitive Adhesive Technology” by Donatas Satas (van Nostrand, New York, 1989).

In order to obtain a preferred polymer glass transition temperature T_{G}≦10° C., in accordance with the above remarks, the monomers are very preferably selected in such a way, and the quantitative composition of the monomer mixture advantageously chosen in such a way, that in accordance with the Fox equation (G1) (cf. T. G. Fox, Bull. Am. Phys. Soc. 1(1956)123), the polymer has the desired T_{G}.

$$\frac{1}{{T}_{G}} = {\sum }_{n} \frac{{w}_{n}}{{T}_{G , n}} \qquad ( G1 )$$

In this equation, n represents the serial number of the monomers used, wₙ denotes the mass fraction of the respective monomer n (in % by weight), and T_{G,n} denotes the respective glass transition temperature of the homopolymer of the respective monomer n, in K.

As monomers for preparing the opposite pressure sensitive adhesive it is preferred to use the monomers already specified for the preparation of the acrylate block copolymers, namely acrylic or methacrylic monomers with hydrocarbon radicals having 4 to 14 carbon atoms, preferably having 4 to 9 carbon atoms (specific examples: methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate, and isooctyl methacrylate), and also monofunctional acrylates and methacrylates of bridged unsubstituted and/or substituted (e.g., by C1-6 alkyl groups, halogen or cyano groups) cycloalkyl alcohols, composed in particular of at least 6 carbon atoms (specific examples: cyclohexyl methacrylates, isobornyl acrylate, isobornyl methacrylates and 3,5-dimethyladamantyl acrylate), and also monomers containing one or more polar groups (e.g., carboxyl, sulfonic and phosphonic acid, hydroxy-, lactam and lactone, N-substituted amide, N-substituted amine, carbamate-, epoxy-, thiol-, ether, alkoxy-, cyano- or the like); additionally, basic monomers are, for example, N,N-dialkyl substituted amides, such as N,N-dimethylacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide.

Further particularly preferred examples of monomers which can be used are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethylacrylic acid, this listing not being exhaustive.

Additionally preference is given to using as monomers vinyl esters, vinyl ethers, vinyl halides, vinylidene halides, vinyl compounds with aromatic rings and heterocycles in a position (examples of the aforementioned: named: vinyl acetate, vinylformamide, vinylpyridine, ethyl vinyl ether, vinyl chloride, vinylidene chloride, and acrylonitrile), and also monomers which possess a high static glass transition temperature, and also aromatic vinyl compounds, such as styrene, preferably with aromatic nuclei made up of C₄ to C₁₈ units, with or without heteroatoms (particularly preferred examples: 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenyl acrylate and methacrylate, 2-naphthyl acrylate and methacrylate, and mixtures of these monomers).

In order to prepare the opposite poly(meth)acrylate PSAs it is advantageous to carry out conventional free-radical polymerizations. For the polymerizations proceeding by a radical mechanism it is preferred to use initiator systems which additionally comprise further radical initiators for the polymerization, especially thermally decomposing, radical-forming azo or peroxo initiators. In principle, however, any customary initiators that are familiar to the skilled worker for acrylates are suitable. The production of C-centered radicals is described in Houben Weyl, Methoden der Organischen Chemie, Vol. E 19a, pp. 60-147. These methods are employed preferentially in analogy.

Examples of radical sources are peroxides, hydroperoxides, and azo compounds; some nonexclusive examples of typical radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. 1,1′-Azobis(cyclohexanecarbonitrile) (Vazo 88™ from DuPont) or azodiisobutyronitrile (AIBN) is very advantageously used as radical initiator.

The average molecular weights M_{N} of the opposite pressure sensitive adhesives formed in the course of the radical polymerization are very preferably chosen such as to be situated within a range from 20 000 to 2 000 000 g/mol; specifically for further use as hotmelt pressure sensitive adhesives, PSAs having average molecular weights M_{N} of from 100 000 to 500 000 g/mol are prepared. The number average molecular weight is determined by size exclusion chromatography (SEC) or matrix-assisted laser desorption/ionization mass spectrometry (MALDI-MS).

The polymerization may be carried out in bulk, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that in the course of monomer conversion the reaction mixture is in the form of a homogeneous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones, and the like, and also derivatives and mixtures thereof.

The polymerization time is between 4 and 72 hours depending on conversion and temperature. The higher the reaction temperature can be chosen, i.e., the higher the thermal stability of the reaction mixture, the lower the reaction time.

For the initiators which undergo thermal decomposition, the introduction of heat is essential to initiate the polymerization. For the thermally decomposing initiators the polymerization can be initiated by heating at from 50 to 160° C., depending on initiator type.

Another advantageous preparation process for the opposite polyacrylate PSAs is anionic polymerization. In this case it is preferred to use inert solvents as the reaction medium, such as aliphatic and cycloaliphatic hydrocarbons, for example, or else aromatic hydrocarbons.

For the technical adhesive properties it may be of advantage to crosslink the opposite PSA. For UV crosslinking it is then preferred to add UV photoinitiators. The photoinitiators may be of the Norrish I or Norrish II type. A number of groups of photoinitiators may be listed, as follows: benzophenone, acetophenone, benzil, benzoin, hydroxyalkylphenone, phenyl cyclohexyl ketone, anthraquinone, trimethylbenzoylphosphine oxide, methylthiophenyl morpholinyl ketone, aminoketones, azobenzoins, thioxanthone, hexarylbisimidazole, triazine, or fluorenone, it being possible for each of these radicals to be further substituted by one or more halogen atoms and/or one or more alkoxy groups and/or one or more amino groups or hydroxyl groups. A representative overview is given in “Photoinitiation, Photopolymerization and Photocuring, Fundamentals and Applications”, by J.-P. Fouassier, Hanser Publishers, Munich, Vienna, New York 1995. For further details, consult “Chemistry & Technology of UV & EB Formulation for Coatings, Inks & Paints”, Volume 5, A. Carroy, C. Decker, J. P. Dowling, P. Pappas, B. Monroe, ed. by P. K. T. Oldring, publ. by SITA Technology, London, England 1994.

Where the opposite pressure sensitive adhesive is applied from solution, it may be of advantage to add from 0.05 to 3% by weight, more preferably from 0.1 to 2% by weight, of crosslinkers, based on the weight fraction of the monomers in the adhesive.

The crosslinker is typically a metal chelate or an organic compound which reacts with a functional group of a comonomer and hence reacts directly with the polymer. For thermal crosslinking, peroxides as well are also suitable. For polymers containing acid groups it is also possible to use difunctional or polyfunctional isocyanates and difunctional or polyfunctional epoxides.

Examples of suitable thermal crosslinkers include aluminum(III) acetylacetonate, titanium(IV) acetylacetonate and iron(III) acetylacetonate. The corresponding zirconium compounds, for example, may also be used for crosslinking, however. Beside the acetylacetonates, the corresponding metal alkoxides, such as titanium(IV) n-butoxide or titanium(IV) isopropoxide, for example, are likewise suitable.

Moreover, for thermal it is possible with particular preference to use polyfunctional isocyanates from Bayer, reference being made here to the trade name Desmodur™. Further crosslinkers may be difunctional or polyfunctional aziridines, oxazolidines or carbodiimides.

It is for crosslinking with actinic radiation, the opposite pressure sensitive adhesive is optionally blended with a crosslinker. Preferred substances which crosslink under radiation, in accordance with the process, are, for example, difunctional or polyfunctional acrylates, including difunctional or polyfunctional urethane acrylates, or difunctional or polyfunctional methacrylates. Simple examples thereof include 1,6-hexanediol diacrylate, pentaerythritol tetraacrylate, trimethylolpropane triacrylate, or 1,2-ethylene glycol diacrylate. However, it is also possible here to use any further difunctional or polyfunctional compounds which are familiar to the skilled worker and are capable of crosslinking polyacrylates under radiation.

For modifying the technical adhesive properties of the prepared poly(meth)acrylates as opposite pressure sensitive adhesives, the polymers are optionally optimized by blending with at least one resin. Tackifying resins to be added include without exception all existing tackifier resins described in the literature. Representatives that may be mentioned include the pinene resins, indene resins, and rosins, their disproportionated, hydrogenated, polymerized, esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resulting adhesive in accordance with what is desired. In general it is possible to use all resins which are compatible (soluble) with the corresponding polyacrylate; mention may be made in particular of all aliphatic, aromatic, and alkylaromatic hydrocarbon resins, hydrocarbon resins based on pure monomers, hydrogenated hydrocarbon resins, functional hydrocarbon resins, and natural resins. Explicit reference is made to the depiction of the state of the art in the “Handbook of Pressure Sensitive Adhesive Technology” by Donatas Satas (van Nostrand, 1989).

In a further advantageous development one or more plasticizers, such as low molecular mass polyacrylates, phthalates, whale oil plasticizers (water-soluble plasticizers) or plasticizing resins, for example, are added to the opposite pressure sensitive adhesive.

The opposite acrylic PSAs may further be blended with one or more additives such as aging inhibitors, light stabilizers, ozone protectants, fatty acids, resins, nucleators, blowing agents, compounding agents and/or accelerators.

Further, they may be admixed with one or more fillers such as fibers, carbon black, zinc oxide, titanium dioxide, solid or hollow glass (micro) beads, microbeads of other materials, silica, silicates, and chalk, with the addition of blocking-free isocyanates also being possible.

Particularly for use as a pressure sensitive adhesive, it may be of advantage if the polyacrylate is applied from the melt as a layer.

For this purpose, the poly(meth)acrylates as described above are concentrated to a hotmelt. This process takes place preferably in a concentrating extruder. Then, in one advantageous variant of the process, the adhesive is applied as a hotmelt in the form of a layer to a carrier or to a carrier material.

Therefore, prior to the crosslinking operation, the poly(meth)acrylates are advantageously applied to a carrier. Coating takes place from solution or from the melt onto the carrier material. For application from the melt, the solvent is preferably stripped off under reduced pressure in a concentrating extruder, possibly using for example single-screw or twin-screw extruders, which advantageously remove the solvent by distillation in different or identical vacuum stages, and which possess a feed preheater. Following concentration, the solvent content is preferably ≦2% by weight, with particular preference ≦0.5% by weight. The poly(meth)acrylate is then advantageously crosslinked on the carrier.

For the crosslinking operation it may be of advantage to subject the opposite PSA to UV radiation. UV irradiation then takes place with a wavelength range from 200 to 450 nm, especially using high or medium pressure mercury lamps with an output of from 80 to 240 W/cm. For UV crosslinking, however, it is also possible to use monochromatic radiation in the form of lasers. In order to prevent overheating it may be appropriate to shade off the UV beam path in part. Further, special reflector systems can be used, functioning as cold light emitters, in order to prevent overheating.

In addition, it may be of advantage to crosslink the opposite acrylic PSA using electron beams. Typical radiating equipment which may be used are linear cathode systems, scanner systems, and/or segmented cathode systems, where said systems are electron beam accelerators. A detailed description of the sate of the art and of the most important process parameters is given in Skelhorne “Electron Beam Processing” in Vol. 1 “Chemistry & Technology of UV & EB Formulations for Coatings, Inks & Paints” published by Sita Technology, London 1991. The typical accelerator voltages are in the range between 50 kV and 500 kV, preferably from 80 kV to 300 kV. The radiation doses employed range between 5 to 150 kGy, in particular from 20 to 100 kGy.

The invention accordingly further provides a pressure sensitive adhesive tape, in particular a double-sided adhesive tape, used in particular for the adhesive bonding of photopolymer printing plates to printing cylinders or printing sleeves, the adhesive tape here composed of at least one carrier and at least two pressure sensitive adhesive layers, at least one of the pressure sensitive adhesives being a physically self-crosslinking acrylic pressure sensitive adhesive.

The invention provides in particular those pressure sensitive adhesive tapes in which at least one of the pressure sensitive adhesives is a self-crosslinking pressure sensitive adhesive of the kind described above, based in particular on acrylate block copolymer.

Suitable carrier materials for the PSA tapes of the invention or the PSA tapes corresponding to the use according to the invention include the films which are customary and familiar to the skilled worker, such as polyesters, PET, PE, PP, BOPP, PVC, etc.), for example. This list is not conclusive. A film of polyethylene terephthalate is particularly preferably employed.

Also suitable for the double-sided PSA tapes of the invention, however, are foam carriers. In a preferred procedure, polymer foams are used, in which case the carrier foams are composed, for example, of polyolefins—especially polyethylene or polypropylene—or of polyurethanes or of polyvinyl chloride.

Through partial etching of the carrier material, in the form of indicia, lines, dots or other designs, for example, it is possible deliberately to strengthen the anchoring of the adhesive at particular points. In this way, preset breakage points are formed, at which the adhesive undergoes transfer when the adhesive tape is demounted. Accordingly, the residues of adhesive, and the damaged adhesive tape itself, disclose removal of the adhesive tape, in the context, for example, of unauthorized opening of cartons.

Generally speaking, an improvement in the anchoring of the pressure sensitive adhesive can be achieved by roughening the carrier material. One way of roughening the carrier material and chemically modifying it is via etching. Besides etching, pretreatment can be carried out in a variety of ways. For instance, for improving anchoring, the carrier materials can be pretreated physically and chemically. For physical treatment, the film is preferably treated by flame or corona or plasma. For chemical pretreatment, the carrier material is given a primer coat, with reactive primer coats being particularly preferably used. Examples of suitable primer materials include reactive primers.

FIG. 1 shows, by way of example, the inventive use by way of a double-sided PSA tape. The adhesive tape is used here for bonding a printing plate which is composed of a PET film 2 and of a layer of a photopolymer 1.

The layers 3 to 9 form a double-sided plate-mounting tape which is compressible owing to its foamed carrier 8.

The layer 3 here is the layer of a self-crosslinking PSA and layer 9 is the opposite PSA layer. Additionally, both layers, 3 and 9, may be based on self-crosslinking PSAs, though it is also possible, as already explained above, for the layer 9 to be the layer based on the self-crosslinking PSA; in that case the comments made above in relation to the PSA layer referred to as opposite apply for the layer 3.

The adhesive tape can advantageously be used both with the layer 3 on the printing plate and with the layer on the printing cylinder or printing sleeve, but adhesive bonding may also take place invertedly (layer 9 for adhesive bonding on the printing plate and layer 3 for adhesive bonding on the printing cylinder or printing sleeve).

Beginning from the side by means of which the printing plate is bonded, the adhesive tape consists of the following individual sections:
3 self-crosslinking pressure sensitive adhesive for anchoring the printing plate, in particular based on block copolymer
4 the roughened top surface of the PET film 5
5 film of polyethylene terephthalate (PET)
6 the roughened bottom surface of the PET film 5
7 pressure sensitive adhesive for anchoring the foamed carrier 8 to the PET 5 film
8 foamed carrier
9 pressure sensitive adhesive for anchoring on the printing cylinder

Specifically in the printing industry it is of significance if the adhesive tapes used here have a high flexibility; that is, if they are able to a certain extent to react with a defined compressibility on application of pressure and/or, when the load is removed, to take up their original form again.

For this reason, in the advantageous embodiment shown here of a double-sided PSA tape for the inventive use, between the polyethylene terephthalate (PET) film and at least one pressure sensitive adhesive there is a foamed carrier, in particular here between the pressure sensitive adhesive facing the printing cylinder or the sleeve and the PET film. It is advantageous, moreover, if the carrier 8 is composed of polyurethane, polyvinyl chloride (PVC) or polyolefin(s). In one particularly preferred embodiment, foamed polyethylenes or foamed polypropylenes are used. It is further preferred if the surfaces of the foamed carrier have been physically pretreated, especially corona-pretreated.

With further preference, the film of polyethylene terephthalate (PET) has a thickness of from 5 μm to 500 μm, more preferably from 5 μm to 60 μm, with very particular preference 23 μm.

In addition to the product structure depicted in FIG. 1, the stabilizing film may also be composed of polyolefins, polyurethanes or PVC. It can be pretreated by etching or another way. For instance, for improving anchoring, the stabilizing films can be pretreated physically and chemically. For physical treatment, the film is preferably treated by flame or corona or plasma. For chemical pretreatment, the film is given a primer coat, with reactive primer coats being used in one particularly preferred embodiment. Examples of suitable primer materials include reactive primers.

In one further preferred procedure, the stabilizing film of PET or another material is printed on one or both sides. This printing may take place under a pressure sensitive adhesive for later application.

For the pressure sensitive adhesives 7, in a preferred way acrylic PSAs are used. The acrylic PSAs comprise, with particular preference to the extent of at least 50% by weight, polymers composed of acrylic and/or methacrylic esters or their free acids, with the following formula
CH₂═CH(R₁)(COOR₂),
where R₁=H or CH₃ and R₂ is a hydrocarbon chain having 1-30 carbon atoms or H.

For the polymerization, the monomers are chosen such that the resulting polymers can be used as pressure sensitive adhesives at room temperature or higher temperatures, especially such that the resulting polymers possess pressure sensitive adhesive properties in accordance with the “Handbook of Pressure Sensitive Adhesive Technology” by Donatas Satas (van Nostrand, New York, 1989).

As monomers for preparing the pressure sensitive adhesive 7 it is preferred to use the monomers already specified for the preparation of the acrylate block copolymers, namely acrylic or methacrylic monomers with hydrocarbon radicals having 4 to 14 carbon atoms, preferably having 4 to 9 carbon atoms (specific examples: methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate, and isooctyl methacrylate), and also monofunctional acrylates or methacrylates of bridged unsubstituted and/or substituted (e.g., by C1-6 alkyl groups, halogen or cyano groups) cycloalkyl alcohols, composed in particular of at least 6 carbon atoms (specific examples: cyclohexyl methacrylates, isobornyl acrylate, isobornyl methacrylates and 3,5-dimethyladamantyl acrylate), and also monomers containing one or more polar groups (e.g., carboxyl, sulfonic and phosphonic acid, hydroxy-, lactam and lactone, N-substituted amide, N-substituted amine, carbamate-, epoxy-, thiol-, ether, alkoxy-, cyano- or the like); additionally, basic monomers are, for example, N,N-dialkyl substituted amides, such as N,N-dimethylacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide.

Further particularly preferred examples of monomers which can be used are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethylacrylic acid, this listing not being conclusive.

Additionally preference is given to using as monomers vinyl esters, vinyl ethers, vinyl halides, vinylidene halides, vinyl compounds with aromatic rings and heterocycles in α position (examples of the aforementioned: named: vinyl acetate, vinylformamide, vinylpyridine, ethyl vinyl ether, vinyl chloride, vinylidene chloride, and acrylonitrile), and also monomers which possess a high static glass transition temperature, and also aromatic vinyl compounds, such as styrene, preferably with aromatic nuclei made up of C₄ to C₁₈ units, with or without heteroatoms (particularly preferred examples: 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenyl acrylate and methacrylate, 2-naphthyl acrylate and methacrylate, and mixtures of these monomers).

In order to prepare the preferred poly(meth)acrylate PSA 7 it is advantageous to carry out conventional free-radical polymerizations. For the polymerizations proceeding by a radical mechanism it is preferred to use initiator systems which additionally comprise further radical initiators for the polymerization, especially thermally decomposing, radical-forming azo or peroxo initiators. In principle, however, any customary initiators that are familiar to the skilled worker for acrylates are suitable. The production of C-centered radicals is described in Houben Weyl, Methoden der Organischen Chemie, Vol. E 19a, pp. 60-147. These methods are employed preferentially in analogy.

Examples of radical sources are peroxides, hydroperoxides, and azo compounds; some nonexclusive examples of typical radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version 1,1′-azobis(cyclohexanecarbonitrile) (Vazo 88™ from DuPont) or azodiisobutyronitrile (AIBN) is used as radical initiator.

The polymerization is preferably carried out in such a way that the average molecular weight M_{N} of the pressure sensitive adhesive 7 formed in the course of the radical polymerization is very preferably within a range from 20 000 to 2 000 000 g/mol; specifically for further use as hotmelt pressure sensitive adhesives, PSAs having average molecular weights M_{N} of from 100 000 to 500 000 g/mol are prepared. The number average molecular weight is determined by size exclusion chromatography (SEC) or matrix-assisted laser desorption/ionization mass spectrometry (MALDI-MS).

For modifying the technical adhesive properties of the prepared PSA 7, the polymer is optionally optimized by blending with at least one resin. Tackifying resins to be added include without exception all existing tackifier resins described in the literature. Representatives that may be mentioned include the pinene resins, indene resins, and rosins, their disproportionated, hydrogenated, polymerized, esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resulting adhesive in accordance with what is desired. In general it is possible to use all resins which are compatible (soluble) with the corresponding polymer which is based on the PSA 7; mention may be made in particular of all aliphatic, aromatic, and alkylaromatic hydrocarbon resins, hydrocarbon resins based on pure monomers, hydrogenated hydrocarbon resins, functional hydrocarbon resins, and natural resins. Explicit reference is made to the depiction of the state of the art in the “Handbook of Pressure Sensitive Adhesive Technology” by Donatas Satas (van Nostrand, 1989).

In a further advantageous development one or more plasticizers, such as low molecular mass polyacrylates, phthalates, whale oil plasticizers (water-soluble plasticizers) or plasticizing resins, for example, are added to the pressure sensitive adhesive 7.

The PSA 7 may further be blended with one or more additives such as aging inhibitors, light stabilizers, ozone protectants, fatty acids, resins, nucleators, blowing agents, compounding agents and/or accelerators.

Further, they may be admixed with one or more fillers such as fibers, carbon black, zinc oxide, titanium dioxide, solid or hollow glass (micro)beads, microbeads of other materials, silica, silicates, and chalk, with the addition of blocking-free isocyanates also being possible.

The PSA 7 is very preferably crosslinked. Crosslinking can be performed in accordance with the methods described above. Crosslinking may be carried out thermally or by actinic radiation. Furthermore, the same methods and additions may be used.

In addition, the adhesive tape of the invention may be provided on one or both sides with a lining of paper or a corresponding film, especially a double-sidedly siliconized liner, in order to ensure longer storage and comfortable handling in the course of service.

Owing to its special properties, the double-sided adhesive tape of the invention is outstandingly suitable for mounting printing plates, especially multilayer photopolymer printing plates, on printing cylinders or sleeves.

In an advantageous procedure, a weakly adhering acrylic PSA 9 is coated onto the side of the adhesive tape (see FIG. 1) which is mounted on the carrier layer of the printing cylinder.

The pressure sensitive adhesive of the layer 9 can in preferred versions be a conventional acrylic PSA or a block copolymer. The adhesive in particular has a bond strength of from 0.5 to 5.5 N/cm, preferably <2.5 N/cm.

The adhesive coating 3 is characterized in particular by a bond strength of from 1 to 6 N/cm, preferably 4.5 N/cm. The bond strengths indicated were measured in accordance with AFERA 4001.

Owing to its special configuration, and particularly with the bond strengths attuned to the printing plate, the adhesive tape of the invention is outstandingly suitable for bonding the printing plates to the printing cylinders. On the one hand, it is possible to reposition the printing plates as often as desired before beginning printing; on the other hand, a secure bond of the plate during the printing process is ensured.

The printing plate can be removed from the PSA tape without any damage whatsoever. Peeling of the carrier layer of the plate or the formation of unwanted creases in the plate during removal does not occur. Moreover, no residues remain after the adhesive tape has been removed from the printing cylinder.

In the text below, the advantages of the adhesive tape of the invention are described in a number of experiments.

### Experiments

The pressure sensitive adhesive tapes of the invention are described below by means of experiments.

The following test methods were employed to evaluate the technical adhesive properties of the pressure sensitive adhesives prepared.

Test Methods

180° Bond Strength Test (Test A)

A strip 20 mm wide of a PSA coated onto siliconized release paper was laminated by transfer to a 25 μm PET film provided with a Saran primer and this PSA tape specimen was then applied to a steel plate washed twice with acetone and once with isopropanol. The PSA strip was pressed onto the substrate twice using a 2 kg weight. The adhesive tape was then immediately removed from the substrate at an angle of 180° and at a speed of 30 mm/min. The steel plates were washed twice with acetone and once with isopropanol.

The results are reported in N/cm and are averaged from three measurements. All measurements were conducted at room temperature under controlled-climate conditions.

Gel Permeation Chromatography (Test B)

The average molecular weights M_{N} and M_{w} and the polydispersity PD were determined by gel permeation chromatography. The eluent used was THF containing 0.1% by volume trifluoroacetic acid. Measurement was carried out at 25° C. The precolumn used was PSS-SDV, 5 μ, 10³ Å, ID 8.0 mm×50 mm. Separation was carried out using the columns PSS-SDV, 5 μ, 10³ and also 10⁵ and 10⁶ each of ID 8.0 mm×300 mm. The sample concentration was 4 g/l, the flow rate 1.0 ml per minute. Measurement was carried out against polystyrene standards.

### Production of Test Specimens

Preparation of a RAFT Regulator:

The regulator bis-2,2′-phenylethyl trithiocarbonate was prepared starting from 2-phenylethyl bromide using carbon disulfide and sodium hydroxide in accordance with instructions from Synth. Comm., 1988, 18 (13), 1531. Yield: 72%. ¹H-NMR (CDCl₃), □: 7.20-7.40 ppm (m, 10 H); 3.81 ppm (m, 1 H); 3.71 ppm (m, 1 H); 1.59 ppm (d, 3 H); 1.53 ppm (d, 3 H).

Preparation of Polystyrene (A):

A 2 L reactor conventional for free-radical polymerization is charged under nitrogen with 362 g of styrene and 3.64 g of bis-2,2′-phenylethyl trithiocarbonate regulator. This initial charge is heated to an internal temperature of 110° C. and initiated with 0.15 g of Vazo 67™ [2,2′-azobis(2-methylbutyronitrile), DuPont]. After a reaction time of 10 hours, 100 g of toluene are added. After a reaction time of 24 hours, initiation is carried out with a further 0.1 g of Vazo 67™ and polymerization is continued for 24 hours. During the polymerization, there is a marked rise in the viscosity. To compensate this, 150 g of toluene are added as final diluent after 48 hours.

For purification, the polymer was precipitated from 4.5 liters of methanol, filtered over a frit, and then dried in a vacuum drying cabinet.

Gel permeation chromatography (Test B) carried out against polystyrene standards gave M_{N}=29 300 g/mol and M_{w}=35 500 g/mol.

Preparation of Polystyrene (B):

A 2 L reactor conventional for free-radical polymerization is charged under nitrogen with 1 500 g of styrene and 9.80 g of bis-2,2′-phenylethyl trithiocarbonate regulator. This initial charge is heated to an internal temperature of 120° C. and initiated with 0.1 g of Vazo 67™ (DuPont). After a reaction time of 24 hours, 200 g of toluene are added. After a reaction time of 36 hours, a further 200 g of toluene are added. During the polymerization there is a marked rise in the viscosity. After 48 hours the polymerization is terminated.

For purification, the polymer was precipitated from 4.5 liters of methanol, filtered off over a frit, and then dried in a vacuum drying cabinet.

Gel permeation chromatography (Test B) carried out against polystyrene standards gave M_{N}=36 100 g/mol and M_{w}=44 800 g/mol.

### Production of the Samples

### EXAMPLE 1

A reactor conventional for free-radical polymerizations was charged with 32 g of trithio-carbonate-functionalized polystyrene (A), 442 g of 2-ethylhexyl acrylate, 35 g of acrylic acid and 0.12 g of Vazo67™ (DuPont). Argon was passed through for 20 minutes and the reactor degassed twice, and then heated to 70° C. with stirring, followed by polymerization for 24 hours. After the ending of the polymerization by cooling to room temperature, dilution was carried out with 250 g of acetone. Gel permeation chromatography (Test B) carried out against polystyrene standards gave M_{N}=114 400 g/mol and M_{w}=217 000 g/mol.

### EXAMPLE 2

A reactor conventional for free-radical polymerizations was charged with 32 g of trithio-carbonate-functionalized polystyrene (A), 442 g of 2-ethylhexyl acrylate, 17 g of acrylic acid and 0.12 g of Vazo67™ (DuPont). Argon was passed through for 20 minutes and the reactor degassed twice, and then heated to 70° C. with stirring, followed by polymerization for 24 hours. After the ending of the polymerization by cooling to room temperature, dilution was carried out with 250 g of acetone. Gel permeation chromatography (Test B) carried out against polystyrene standards gave M_{N}=98 400 g/mol and M_{w}=185 000 g/mol.

### EXAMPLE 3

A reactor conventional for free-radical polymerizations was charged with 700 g of trithio-carbonate-functionalized polystyrene (B), 3 063 g of n-butyl acrylate and 1 600 g of acetone. Under nitrogen and with stirring, this initial charge was heated to an internal temperature of 65° C. and 0.1 g of Vazo67™ (DuPont) was added. With stirring, the reactor was heated to 70° C. and polymerization was carried out for 24 hours. After a reaction time of 4 hours, the batch was diluted with 300 g of acetone. After 19 hours, dilution was again carried out with 300 g of acetone. After the end of the polymerization by cooling to room temperature, dilution was carried out with 750 g of acetone. Gel permeation chromatography (Test B) carried out against polystyrene standards gave M_{N}=111 300 g/mol and M_{w}=197 000 g/mol.

### Bond Strength Determination of Examples 1-3

For use as pressure sensitive adhesives, the bond strength to steel of examples 1 to 3 was measured as well. Examples 1 to 3 were coated from solution onto a PET film 25 μm thick (see test method A). After drying in a drying cabinet at 120° C. for 20 minutes, the amount of adhesive applied was 50 g/m². The measurements are summarized in table 1.

TABLE 1

| | BS - steel |
|---|---|
| Example | [N/cm] |
| 1 | 5.1 |
| 2 | 3.8 |
| 3 | 3.6 |

BS: Bond strength to steel 50 g/m² application rate

### Production of the Double-Sided PSA Tape Assembly

A PET film 25 μm thick and etched on both sides with trichloroacetic acid was coated with examples 1, 2 or 3 (corresponding to layer 3, cf. FIG. 1). Following drying, the amount of adhesive applied was 20 g/m². For this purpose the film was coated directly from solution in each case with one of examples 1 to 3 and dried at 100° C. for 30 minutes. The specimens thus coated were lined with a double-sidedly siliconized release paper. Subsequently, a commercially customary acrylic PSA (corresponding to layer 7, cf. FIG. 1) was laminated via a transfer support onto the uncoated side of the existing assembly, with an application rate of 20 g/m².

In the following step, an EVA foam with a thickness of 500 μm and a density of 200 kg/m³ was laminated on. Then, again via a transfer support, a commercially customary acrylic PSA (corresponding to layer 9, cf. FIG. 1) was laminated onto this foam carrier, onto the uncoated side of the existing assembly, at an application rate of 50 g/m².

### Adhesive Bonding of Printing Plates and Use

In each case, one of the double-sided PSA tapes described above with the adhesive side lying open (see FIG. 1, layer 9) were stuck onto a steel cylinder having a diameter of 110 mm. On top of this, a printing plate from DuPont Cyrel® HOS with a thickness of 1.7 mm (with layer 2, cf. FIG. 1) was bonded to the PSA of the adhesive tape (layer 3 in FIG. 1). This steel cylinder with printing plate was subsequently inserted into a printing machine where it was used for printing for 16 hours with a print setting of 150 μm. For all of the examples, the printing plate was very easy to remove by hand from the double-sided adhesive tape, without any residue.

1. A method of bonding a printing plate to a printing substrate, said method comprising bonding the printing plate to a pressure sensitive adhesive tape comprising a self-crosslinking acrylic pressure sensitive adhesive.

2. The method as claimed in claim 1, wherein the pressure sensitive adhesive is in the form of at least one layer, said at least one layer of the pressure sensitive adhesive having adhesive and nonadhesive regions.

3. The method as claimed in claim 1, wherein the pressure sensitive adhesive tape comprises at least one carrier.

4. The method as claimed in claim 2, wherein the at least one layer of the pressure sensitive adhesive, in adhesive bonding of the printing plate, is on a side of the pressure sensitive adhesive tape that faces the printing plate.

5. The method as claimed in claim 1, wherein the pressure sensitive adhesive is based on at least one block copolymer.

6. The method as claimed in claim 5, wherein the at least one block copolymer comprises at least one unit P(A)-P(B)-P(A) composed of at least one polymer block P(B) and at least two polymer blocks P(A), where
P(A) independently of one another represent homopolymer and/or copolymer blocks of monomers A, the polymer blocks P(A) each having a softening temperature in the range from +20° C. to +175° C.,
P(B) represents a homopolymer or copolymer block of monomers B, the polymer block P(B) having a softening temperature in the range from 130° C. to +10° C., and
the polymer blocks P(A) and P(B) are not homogeneously miscible with one another.

7. A double-sided pressure sensitive adhesive tape, comprising at least one carrier and two pressure-sensitive adhesive layers, wherein at least one of the pressure-sensitive adhesives is a self-crosslinking acrylic pressure-sensitive adhesive.

8. The pressure sensitive adhesive tape as claimed in claim 7, wherein the self-crosslinking pressure sensitive adhesive is based on at least one block copolymer.

9. The method as claimed in claim 1, wherein the printing substrate is at least one of a printing cylinder and a printing sleeve.

10. The method as claimed in claim 3, wherein the carrier is in the form of at least one of a film and a foam.

11. The method as claimed in claim 3, wherein the at least one layer of the pressure sensitive adhesive, in adhesive bonding of the printing plate, is on a side of the pressure sensitive adhesive that faces the printing plate.

12. The pressure sensitive adhesive tape as claimed in claim 8, wherein the at least one block copolymer comprises at least one unit P(A)-P(B)-P(A) composed of at least one polymer block P(B) and at least two polymer blocks P(A), where
P(A) independently of one another represent homopolymer and/or copolymer blocks of monomers A, the polymer blocks P(A) each having a softening temperature in the range from +20° C. to +175° C.,
P(B) represents a homopolymer or copolymer block of monomers B, the polymer block P(B) having a softening temperature in the range from 130° C. to +10° C., and
the polymer blocks P(A) and P(B) are not homogeneously miscible with one another.
